(19) United States
(12) Patent Application Publication
(10) Pub. No.: US 2006/0162255 A1
(43) Pub. Date: Jul. 27, 2006

(54) Protective apparatus for hinged doors

(75) Inventor: Vincent J. Lee, Cerritos, CA (US)

Correspondence Address: Edward E. Roberts, P.O. Box 3206, Dana Point, CA, 92629, US

(73) Assignee: JODAVI, INC.

(21) Appl. No.: 11/198,778

(22) Filed: Aug. 8, 2005

Related U.S. Application Data
(60) Provisional application No. 60/646,581, filed on Jan. 25, 2005.

(51) Int. Cl. E06B 11/00

(52) U.S. Cl. 49/383; 49/381

(57) ABSTRACT

Door closure protective apparatus for hinged doors including a door frame, a door having hinge means for attachment to said door frame for pivotal movement to swing between a closed and open position wherein such movement leaves an open space between mating faces of said door frame and said door when said door is an said open position, the apparatus including a frame mounting member, a spring attachment member mounted to said frame mounting member, a longitudinally extending spring having one end attached to the spring attachment member and the other end attached to an obstruction member such as a ball, the combination configured and arranged such that the obstruction member overlays said door when said door is in the closed position and enters the open space to restrict closing of the door when the door is opened.

### CLAIM FOR BENEFIT OF EARLIER FILING DATE

The present utility application claims the benefit of U.S. Provisional Application No. 60/646,581 filed on 25 Jan. 2005 and entitled “PROTECTIVE APPARATUS FOR HINGED DOORS”. The present utility application has the same inventor, subject matter and title as the aforesaid Provisional Application.

### BACKGROUND

The background of the invention will be discussed in two parts.

1. Field of the Invention

This invention relates to door safety features and more particularly to a safety device for preventing insertion of a persons fingers, or other foreign objects, into the opening between a door and the door frame during close of hinged swinging doors hung in a doorframe.

2. Description of the Prior Art

Dangers presented to the fingers of users wherein they are inserted into the opening between a corner edge of the door and the door frame of hinged swinging doors, and then being caught during closure of the door are well known. Other foreign objects inadvertently caught during such door closure also are of concern. Consequently, various prior art safety devices or arrangements have been developed in an effort to provide simple safety features for hinged swinging doors.

One such device is shown and described in U.S. Pat. No. 3,941,180 issued to Thill on 2 Mar. 1976 wherein there is disclosed an elaborate guard rail assembly for hinged sectional garage doors. The assembly includes a pocket built into an extension of one of the door panels for receiving a rigid arcuate member, built into the mating door panel, in the closed panel position that covers the gap between the panels in the open panel position.

Another such protective assembly is shown and described in U.S. Pat. No. 4,290,233 issued to Hubbard on 13c Sep. 1981. The assembly discloses a protective device for swinging hinged doors that includes an elaborate pivotal hinge assembly, one element thereof attached to the door and another element thereof attached to the door frame. An arcuate member of one of the elements is enclosed within a pocket in the other element when the door is closed and bridges the gap when the door is opened.

Another such device is shown and described in U.S. Pat. No. 3,319,697 issued to Krohn on 16 May 1967 wherein there is disclosed a finger guard assembly for overhead-roll-type garage doors. The assembly includes an arcuate plate on one panel having a coiled spring for urging the arcuate plate to maintain contact with the other panel to cover the open gap when the panels are angularly disposed relative to each other.

Such devices are illustrative of the varied arrangements whereby attempts have been made to improve and simplify hinged swinging door closure configurations for providing increased operational safety and convenience in the close of the doors. However, what is needed is a improved door operation configuration for hinged swinging doors that is inexpensive to manufacture, simple to install, and provides necessary protection for fingers and other foreign objects from being caught upon closure of the door.

It is thus an object of the present invention to provide a new and improved configuration for hinged swinging doors that prevents fingers or other foreign objects from being caught between the opening formed between the door frame and the edge of the door when the door is closed.

It is another object of the invention is to provide new and improved protective apparatus for hinged doors that is easily mounted, detached and re-attached with only simple tools and without modification of the door.

### SUMMARY

The foregoing and other objects and advantages of the invention are accomplished by providing a new and improved door configuration that is inexpensive to manufacture, simple to install, and provides necessary protection for fingers and other foreign objects from being caught upon closure of a hinged swinging door. The configuration prevents insertion of fingers or other foreign objects into the opening formed between the door frame and the edge of the door when the door is closed.

The safety apparatus consists in one embodiment of a generally soft and resilient member such as a ball that is spring mounted to the door frame such that when the door is closed the ball overlays the edge of the door but when the door is opened, by spring action the ball is positioned such that the door is prevented from closing. The ball may be easily pushed aside so that the door can be closed. The apparatus may be mounted at a height such that a child cannot reach the ball. Although a ball is shown in the drawings and described herein, it is to be understood that other configurations may be used and that such configurations may include features such as audible means activated upon contact and attractive decorations.

Other aspects, features and advantages of the invention will become apparent from a reading of the specification, when taken in conjunction with the drawings, wherein like reference numerals indicate like elements in the several views.

### DRAWINGS

FIG. 1A is a plan view of the protective apparatus of the invention illustrating how the door stop overlays the door when the door is in the closed position;

FIG. 1B is a plan view illustrating how the door stop of FIG. 1A by spring action is moved into position after the door is opened to thus prevent the door from closing;

FIG. 1C is a plan view illustrating how the door stop of FIG. 1A can be moved aside to allow closing of the door;

FIG. 2A is a top view of the door stop of FIG. 1 illustrating the position of the door stop when the door is in the closed position;

FIG. 2B is a top view of the door stop of FIG. 1 illustrating how by spring action the door stop is moved aside when the door is opened;

FIG. 2C is a top view of the door stop of FIG. 1 illustrating how after the door is opened the member swings back into position to prevent closure of the door;

FIG. 2D is a top view of the door stop of FIG. 1 illustrating how the door stop is pushed aside to permit closure of the door;

FIG. 2E is a top view of the door stop of FIG. 1 illustrating how the door stop overlays the door after it is closed;

FIG. 3 is a cross sectional view of the door stop ball configuration illustrating attachment of the spring element of the invention to the ball;

FIG. 4 shows another embodiment of the protective apparatus of the invention indicating the angle α positioning range for both right hinged and left-hinged doors;

FIG. 5 illustrates mounting of one half of a mating element for changing the positioning angle α range for both right hinged and left-hinged doors;

FIG. 6 illustrates mounting of the other half of the mating element of FIG. 6 for changing the angle α positioning range for both right hinged and left-hinged doors;

FIG. 7A is a cross sectional view taken along lines 7A, 7B of FIG. 4 illustrating the configuration of the invention for manually changing the positioning angle α for both right hinged and left-hinged doors; and

FIG. 7B is a cross sectional view taken along lines 7A, 7B of FIG. 4 illustrating how the configuration of FIG. 7A is manually manipulated to change the positioning angle α.

### DESCRIPTION

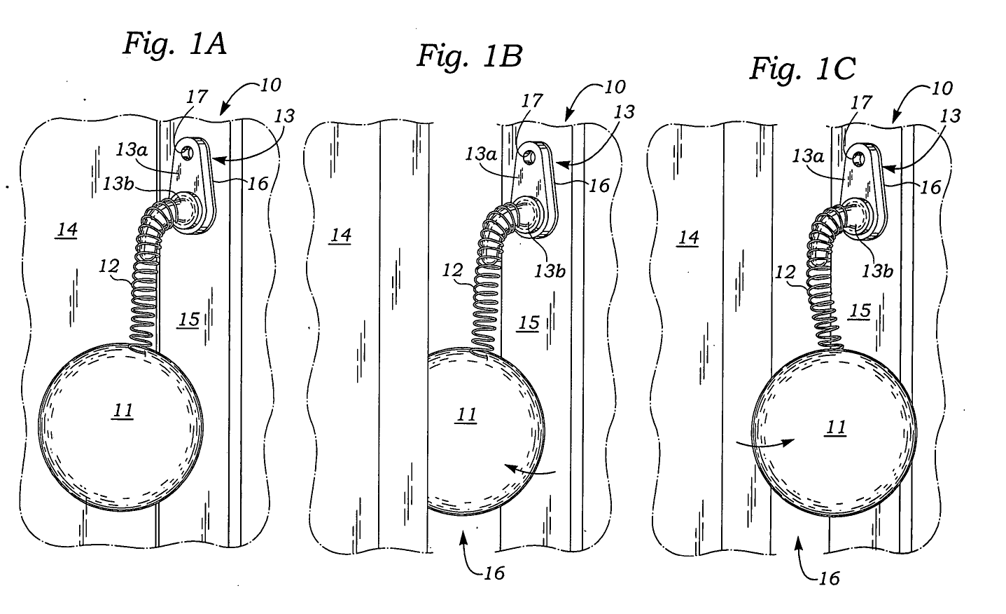

Referring now to the drawings, FIGS. 1A, 1B, and 1C illustrate an embodiment of the protective apparatus according to the invention wherein the configuration prevents insertion of fingers or other foreign objects into the opening formed between the frame of a door and the edge of the door when the door is closed.

FIG. 1A illustrates the apparatus of the invention, generally designated by reference numeral 10, mounted to a door frame 15 having a door 14 in the closed position. The apparatus of the invention includes door stop 11, spring 12, and a mounting member, generally designated 13 that includes base 13a, spring attachment 13b, and aperture 17 for mounting of base 13A to door frame 15. Base 13a may be mounted to door frame 15, other than as indicated by aperture 17, in any appropriate manner, such as with adhesive 18. Spring attachment 13b is attached to base 13a at an angle from the vertical such that in the door closed position door stop 11 overlays door 14 as will be further discussed infra. Door stop 11 is generally of a soft resilient material and although shown with a ball configuration it may have any configuration appropriate with the operation of the invention as described. Door 14 is shown mounted for swinging movement by a common plurality of hinges (not shown), and in the figures is shown to open to the left (left-hinged). It is to be understood that the invention works equally as well for right-hinged doors.

FIG. 1B illustrates how, upon opening of the door 14 An opening, generally designated 16, is exposed when the adjacent corner edges of the door 14 and door frame 15 are displaced relative to each other. This-opening 16 presents a clear opportunity for a person's finger(s), or other foreign objects, to be inadvertently inserted into the opening 16 and caught when the door 14 is closed. Also illustrated, by the arrow, is the manner in which door stop 11, by action of spring 12, is positioned in opening 16 between the edge of door 14 and door frame 15 after door 14 is opened, thus preventing the door 14 from closing.

FIG. 1C illustrates, by the arrow, how door stop 11 is moved out of opening 16 to permit closing of door 14; with door stop 11 urged by spring 12 to again overly the edge of closed door 14 as shown in FIG. 1A.

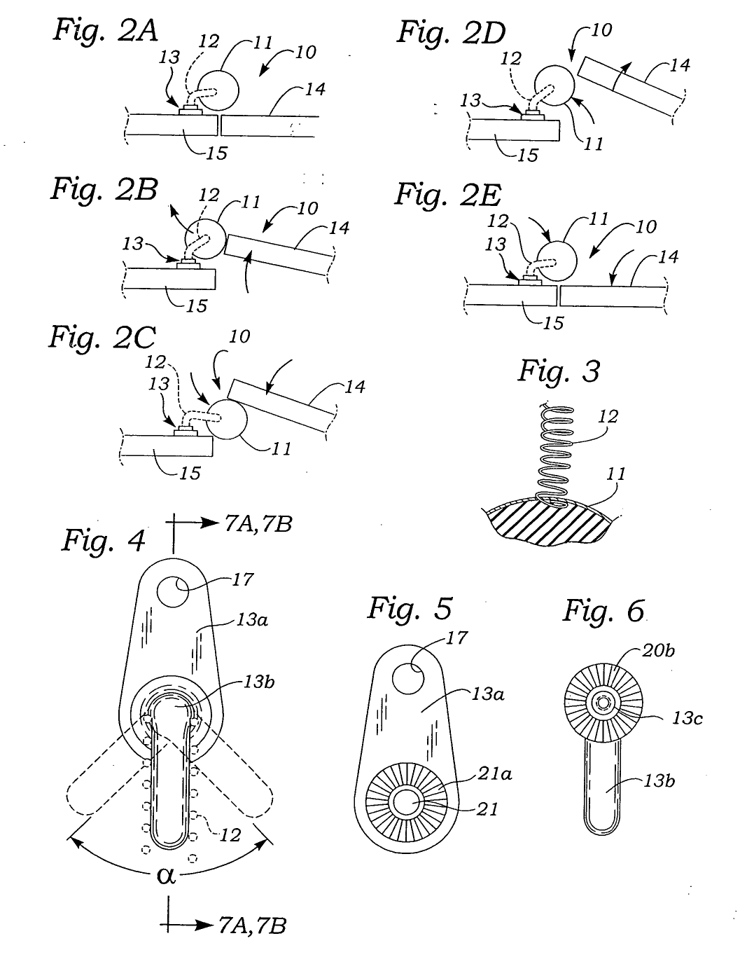

FIGS. 2A-2E further illustrate the operation of the invention, FIG. 2A being a top view of the apparatus 10 of the invention and illustrating the position of door stop 11 when the door 14 is in the closed position. As seen, the angular orientation of spring attachment 13b from the vertical, in combination with the resultant urging of spring 12, has urged door stop 11 to overlay a portion of door 14.

FIG. 2B illustrates the manner in which door stop 11 is pushed aside when the door 14 is opened, door 14 applying force to door stop 11 which in turn moves against the tension of spring 12 to thus allow door 14 to close.

FIG. 2C illustrates how upon further opening of door 14 the tension of spring 12 forces door stop 11 into the vacated space, or opening 16, between door 14 and door frame 15, and thus upon the attempt to close door 14, door stop 11 prevents such closing while at the same time cushioning the impact of door 14 against door stop 11.

FIG. 2D illustrates door 14 being opened slightly and door stop 11 then moved out of the opening 16 between door 14 and door frame 15 so that as shown in FIG. 2E the door 14 can then be closed and under tension of spring 12 the door stop 11 again overlays the door 14 as shown in FIG. 2E (and also in FIG. 2A).

FIG. 3 is a simplified illustration in cross section of one embodiment of the door stop 11 wherein it is indicated to be generally ball shaped with one end of the spring 12 embedded in the door stop 11 with the other end attached to spring attachment 13b as variously indicated in the drawings. As mentioned previously, door stop 11 may have a ball configuration or any other suitable configuration, such as a teddy bear, and is generally of a soft resilient non-toxic material.

FIG. 4 illustrates an embodiment of the invention in which base 13a has spring attachment 13b pivotally mounted thereto to permit variation of the orientation of spring attachment 13b to base 13a through the positioning angle α. Since the angular orientation of spring attachment 13b in combination with the resultant urging of spring 12 dictates the position of door stop 11 within opening 16, and the overlaying of the edge of door 14, variation of the angular orientation may often be desirable for proper mounting of the apparatus 10 to the door frame 15, or other surface as may be necessary.

FIG. 5 illustrates, in front view of base 13a, one half of a mating element in accordance with the embodiment of FIG. 4. As shown, base 13a includes integrally formed teethed element 20a that forms one half of the mating element. Although shown as teethed, element 20a could take any configuration in keeping with the invention. Also shown is circular aperture 21 that extends through base 13a as will be further described.

FIG. 6 illustrates the other half of the mating element for varying the angle α. Shown is teethed element 20b formed integral with spring attachment 13b for co-acting engagement with element 20a whereby a selected angle α is fixedly maintained. Also shown is extension 13c of spring attachment 13b that is dimensioned for insertion through aperture 21 as will be further described.

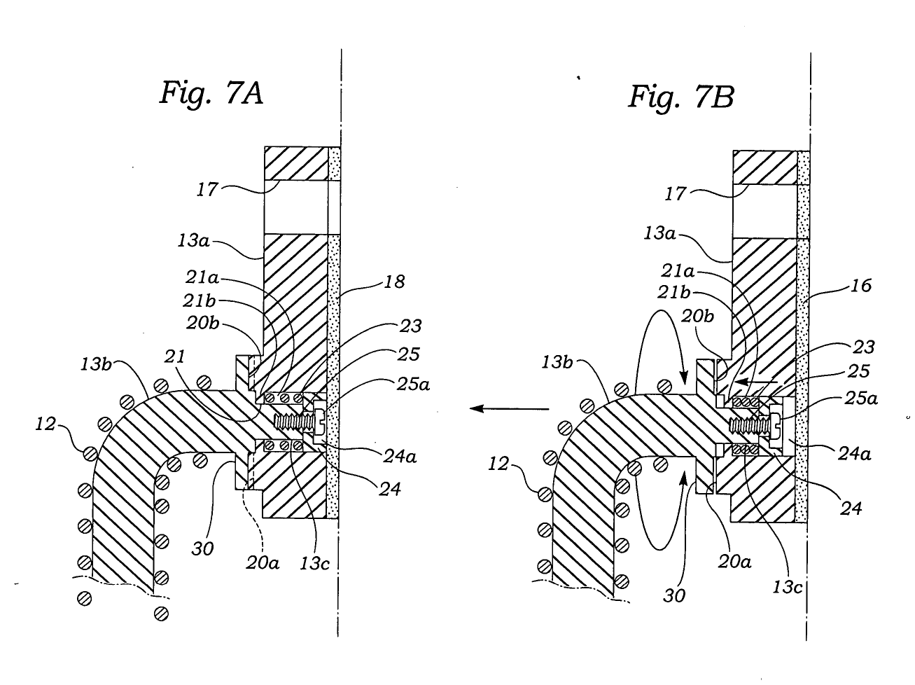

FIG. 7A is a cross sectional view taken along lines 7A,7B of FIG. 4 that further illustrates the embodiment for varying the positioning angle α and shows teethed elements 20a and 20b initially engaged to define an angle α setting. Aperture 21 is configured for rotatably receiving circular extension 13c and is counter-bored from the rear of spring attachment 13b to provide enlarged aperture 21 a and reduced diameter flanged shoulder 21b at the entrance of aperture 21. Extension 13c is inserted through aperture 20 past shoulder 21b and partially through counter-bored aperture 21a, extension 13c being foreshortened in length leaving an opened space before the entrance to counter-bore 21a. Circular retaining spring 23 is fitted over extension 13c to abut flanged shoulder 21b and then is retained under tension by retainer 24 which is attached to extension 13c by screw 25.

Retainer 24 is circular with a diameter slightly smaller than that of aperture 21a and in cross section is generally staple-shaped with a flat bottom. It is fastened to extension 13c with the flat bottom abutting spring 23. With the retainer 24 securely attached to extension 13c with the flat bottom abutting retaining spring 23, the open portion 24a of the retainer 24 extends to the opening of aperture 21a with the head 25a of the screw 25 within the open portion 24a.

FIG. 7B is a cross sectional view taken along lines 7A,7B of FIG. 4 that illustrates changing of the position angle α. Teethed element 20b is disengaged from teethed element 20a as indicated by the horizontal arrow and in the process compresses retainer spring 23. Spring attachment 13b is then rotated as indicated by the circular arrows and elements 20a, 20b are reengaged at a different location to thus vary the angle α. This new position is then maintained by the expansion of retainer spring 23.

Thus, the apparatus of the invention operates to provide protection from possible injury when the door 14 is opened sufficiently for door stop 11 to enter the opening 16. In some cases the door frame 15 will be inadequate for mounting of the apparatus of the invention, in which case the apparatus can be mounted in sufficient proximity to the door 14 and the angle α adjusted as necessary in keeping with the invention.

There has thus been shown and described in a basic configuration protective apparatus preventing insertion of fingers or other foreign objects into the opening formed between the door frame and the edge of a door when the door is closed. Although the present invention has been described with reference to illustrated and described embodiments, other modifications and embodiments can be devised by those skilled in the art that that would fall within the spirit and scope of the invention. For instance, door stop 11 may be of any suitable configuration and spring 12 may take another configuration and be mounted to door stop 11 and base 13 in other suitable fashions within the scope of the invention.

What is claimed is:

1. Door closure protective apparatus for hinged doors comprising:
a door frame and a door, said door having hinge means for attachment to said door frame for pivotal movement to swing between a closed and an open position;
protective apparatus mounted to said door frame adjacent closure mating faces of said door frame and said door and including means for obstructing closure of the opened door; and
said protective apparatus includes a frame mounting member having a spring attachment member, a longitudinally extending spring having a first and a second end, and an obstruction member urged by said spring into the open space between said frame and said opened door.

2. The protective apparatus of claim 1 wherein said frame attachment member is mounted to said frame, said spring attachment member is attached to said first end of said spring, and said obstruction member is attached to said second end of said spring.

3. The protective apparatus of claim 2 wherein the combination of said frame attachment member, said spring and said obstruction member is configured and attached such that said obstruction member overlays said door when said door is in the closed position.

4. The protective apparatus of claim 2 wherein the combination of said frame attachment member, said spring and said obstruction member is configured and attached such that said obstruction member is urged by said spring into the open space between said frame and said opened door.

5. The protective apparatus combination of claim 4 wherein said combination provides for ready displacement of said obstruction member from said open space whereby with closure of said door said obstruction member again overlays said door.

6. The protective apparatus combination of claim 4 wherein said obstruction member is soft and resilient and has the configuration of a ball.

7. The protective apparatus of claim 5 wherein said frame mounting member and said spring attachment member have co-acting engagement means for varying the orientation of said spring attachment member with respect to said frame mounting member thereby to vary the horizontal displacement of said obstruction member.

8. The protective apparatus of claim 7 wherein said engagement means includes a hold and release mechanism for repositioning the orientation of said flame attachment member with respect to said frame mounting member.

9. The protective apparatus of claim 7 wherein said frame attachment member and said frame mounting member have complimentary engagement mating surfaces for fixing the orientation of said frame attachment member with respect to said frame mounting member, and said frame mounting member includes hold and release means for repositioning the orientation of said spring frame attachment member with respect to said spring frame attachment member.

10. The protective apparatus of claim 9 wherein said hold and release means includes in combination
said spring attachment member having a circular terminating end for mating with said frame attachment member;
said frame attachment member having an aperture configured for rotatably receiving said terminating end;
said aperture counter-bored to provide a shoulder at the entrance thereof;
a flanged end plate for attachment to the end of said spring attachment member within said aperture;
resistance spring means for placement between said shoulder and said end plate to resist displacement of said engagement means; and
wherein said engagement means are separated against said resistance spring, said spring attachment member is repositioned relative to said frame mounting member, and said resistance spring means reacts to hold said spring attachment member in the new position.

11. Door closure protective apparatus for hinged doors including a door frame, a door having hinge means for attachment to said door frame for pivotal movement to swing between a closed and open position wherein such movement leaves an open space between mating faces of said door frame and said door when said door is an said open position, said apparatus comprising in combination:
a flame mounting member;
a spring attachment member mounted to said frame mounting member;
a longitudinally extending spring having a first and second end, said first end attached to said spring attachment member;
an obstruction member attached to said second end of said spring; and
wherein said combination is configured and attached such that said obstruction member overlays said door when said door is in the closed position.

12. The protective apparatus of claim 11 wherein said combination provides that said obstruction member is urged by said spring into said open space between said frame and said opened door;

13. The protective apparatus of claim 12 wherein said combination includes hold and release means whereby said spring attachment member may be repositioned with respect to said frame mounting member to thereby vary the orientation of said obstruction member.

14. The protective apparatus of claim 13 wherein said hold and release means includes in combination
said spring attachment member having a circular terminating end for mating with said frame attachment member;
said frame attachment member having an aperture configured for rotatably receiving said terminating end;
said aperture counter-bored to provide a shoulder at the entrance thereof;
a flanged end plate for attachment to the end of said spring attachment member within said aperture;
resistance spring means for placement between said shoulder and said end plate to resist displacement of said engagement means; and
wherein said engagement means are separated against said resistance spring, said spring attachment member is repositioned relative to said frame mounting member, and said resistance spring means reacts to hold said spring attachment member in the new position.

15. The protective apparatus combination of claim 14 wherein with displacement of said obstruction member from said open space said obstruction member again overlays said door with closure of said door.
